(19) United States
(12) Patent Application Publication
(10) Pub. No.: US 2012/0137800 A1
(43) Pub. Date: Jun. 7, 2012

(54) PARKING RELEASE ACTUATOR

(75) Inventors: Hangil Park, Hwaseong-si (KR); Changhyun Lee, Seoul (KR); Jungki Kim, Daegu (KR); Yongkuk Kim, Ulsan (KR)

(73) Assignees: Hyundai Motor Company, Seoul (KR); SL Corporation, Dae-gu (KR); Kia Motors Corporation, Seoul (KR)

(21) Appl. No.: 13/285,326

(22) Filed: Oct. 31, 2011

(30) Foreign Application Priority Data
Dec. 6, 2010 (KR) 10-2010-0123863

(51) Int. Cl. F16H 19/08

(52) U.S. Cl. 74/89.14; 74/89.2

(57) ABSTRACT

In a parking release actuator, a related motion between a motor and a cable uses a number of worm gears and worm wheel gears using rotation motions in different directions, and the cable is pulled or released by a cable guide converting a rotation motion into an angular motion. Therefore, a number of worm gears and worm wheel gears and the cable guide are made compact and intensive. As a result, it is possible to reduce the entire size of a housing and significantly reduce the operation of the operator required for manual locking or manual release, thereby further improving convenience.

### CROSS-REFERENCE TO RELATED APPLICATIONS

The present application claims priority to Korean Patent Application Number 10-2010-0123863 filed Dec. 6, 2010, the entire contents of which application is incorporated herein for all purposes by this reference.

### BACKGROUND OF INVENTION

1. Field of Invention

The present invention relates to a parking release actuator, and more particularly, to a parking release actuator using a two-stage worm gear to reduce friction of an operation unit, the weight, and the costs.

2. Description of Related Art

In general, a shift by wire (SBW) system for a vehicle is a transmission operating system without a mechanical connection structure between a transmission and a gear shifting lever which is removed by using an actuator, an electronic gear shifting lever, and a controller (or an ECU).

FIG. 7 is a view illustrating a configuration of a parking release actuator (PRA) according to the related art.

The parking release actuator (PRA) includes a motor pinion 110 connected to a motor 100 which is a power source, a transmission gear 120 engaged with motor pinion 110 to rotate, an operation gear 130 engaged with transmission gear 120 to rotate, a power screw 140 fixed to operation gear 130 to rotate together with operation gear 130, and a trust collar 150 moving up or down along a rotation direction of power screw 140 to pull a cable 200 or release cable 200.

The parking release actuator uses a method of moving trust collar 150 up and down according to the rotation direction of power screw 140 and thus has an advantage in which the fastening power between power screw 140 and trust collar 150 is good.

However, the above-mentioned operation method of power screw 140 and trust collar 150 is inefficient in the performance aspect except for good fastening power.

That is, trust collar 150 has a relatively long stroke along power screw 140 and thus is disadvantageous in the operation time and operation noise aspects.

Especially, in a case where the parking release actuator should be manually locked or released by using a tool groove provided to power screw 140, since the long stroke of trust collar 150 needs an operation of an operator more than necessary, the operation efficiency of the parking release actuator is low and the operator feels more uncomfortable.

A housing 160 of the parking release actuator should be formed to have a large width and height because the width is widened due to motor 100 and power screw 140 aligned with transmission gear 120 interposed therebetween and the height increases due to a movement of trust collar 150 which moves up or down along power screw 140.

However, if the size of housing 160 is large, the package space efficiency at an installation position is low and the cost increases together with an increase of the total weight.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a parking release actuator capable of implementing pulling and releasing of a cable by a rotation method to make a structure compact, to reduce an entire size, and to significantly improve a package space efficiency at an installation position, and reducing the number of gears to reduce operation noise and to significantly reduce the weight and cost.

Various aspects of the present invention provide for a parking release actuator including a motor which is a power source, a gear unit aligned to be perpendicular to the motor, and outputting power of the motor as a final torque in an opposite direction to a rotation direction of the motor, a cable guide performing an angular motion according to the output of the gear unit to pull or release a cable according to a rotation direction of the angular motion, a sensor generating a detection signal for stopping the motor such that the cable guide is positioned in a predetermined angular motion range, a manual operation unit formed in the gear unit to rotate the gear unit by using a tool, and a housing containing the gear unit, the cable guide, and the sensor perpendicular to a containing portion of the motor, and having a hole through which the tool is inserted.

The housing may include an inner cover and an outer cover having shapes corresponding to each other and joined with each other, and the inner cover may have a motor containing unit containing the motor.

The gear unit may include a motor gear joined with the motor in a shaft direction of the motor to rotate, a transmission gear perpendicular to a side surface of the motor gear and rotating by the motor gear, and an operation gear fixed to the housing by a pin shaft to rotate on a side surface of the transmission gear by the transmission gear.

The transmission gear may include a worm wheel engaged with a worm gear formed in an outer circumferential surface of the motor gear, and a worm shaft fixed to a shaft center of the worm wheel, perpendicular to the worm wheel, and provided with a worm gear formed in an outer circumferential surface engaged with a worm wheel gear formed in the edge of the worm wheel.

A tool groove may be formed in an end surface of the worm shaft to join with the tool as the manual operation unit.

The cable guide may include an extension end extending in a fan shape from a shaft center portion fixed to the rear of the operation gear by the pin shaft, and a fixing hole may be made in the extension end to fix the cable.

A groove may be formed in an edge surface of the extension end to wind the cable, and the fixing hole may be formed at a position forming 90 degrees with one side portion of the extension end.

The sensor may include a magnet having a north pole and a south pole, and a senor printed circuit board (PCB) sensing a position change of the magnet and generating an electric signal to be transmitted to a controller.

The north pole and the south pole of the magnet may be formed on both sides of left and right relative to a shaft center of the operation gear in an arc shape occupying an area smaller than 90 degrees, respectively.

According to various aspects of the present invention, the rotation method using fewer gears may be implemented to pull and release the cable. Therefore, it is possible to significantly reduce the operation noise and reduce the weight and cost to 50% as compared to the related art.

Further, since the actuator of the present invention may be configured with fewer gears, it is possible to improve operation efficiency, and since the actuator of the present invention may be made compact, it is possible to significantly improve the package space efficiency at the installation position.

Furthermore, according to various aspects of the present invention, since the rotation method is implemented to pull and release the cable, when manual locking or releasing using a tool is required, it is possible to significantly reduce the operation of the operator so as to further improve the convenience.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a configuration of an exemplary parking release actuator according to the present invention.

FIG. 2 is a cross-sectional view illustrating an assembled state of an exemplary parking release actuator according to the present invention.

FIGS. 3 and 4 are views illustrating operations when an exemplary parking and parking release automatically implemented according to the present invention.

FIGS. 5 and 6 are views illustrating operations when an exemplary parking and parking release manually implemented according to the present invention.

FIG. 7 is a view illustrating a configuration of a parking release actuator according to the related art.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

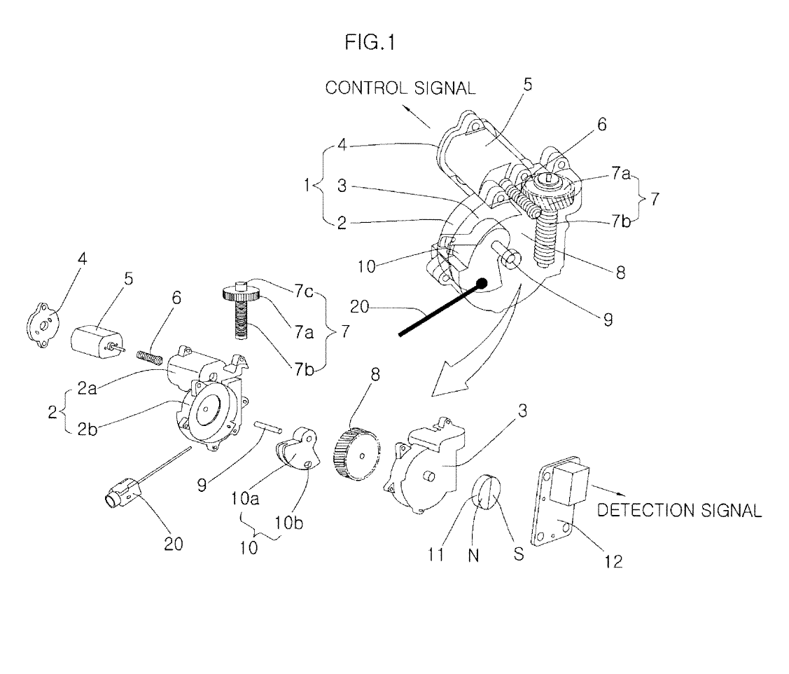

Referring to FIG. 1, a parking release actuator (PRA) includes a housing 1 forming the whole appearance, a motor 5 which is a power source, a gear unit perpendicular to motor 5 and reducing the rotation of motor 5 to increase an output torque, a cable guide 10 performing an angular motion along the rotation direction of the gear unit to pull or release a cable 20, a sensor sensing a position change of cable guide 10 by the angular motion, and a manual operation unit formed in the gear unit to rotate the gear unit by using a tool.

Housing 1 includes an inner cover 2 perpendicular to a motor containing unit 2a containing motor 5 and forming an instrument containing unit 2b containing the gear unit, and an outer cover 3 having a shape corresponding to instrument containing unit 2b of inner cover 2 and joined with inner cover 2.

Inner cover 2 is joined with a motor cover 4 to cover the rear side of motor 5 contained in motor containing unit 2a of inner cover 2.

Motor 5 is controlled by a controller (or an ECU) of a shift by wire (SBW) system.

The gear unit includes a motor gear 6 joined with motor 5 in the shaft direction of motor 5 and rotating by motor 5, a transmission gear 7 perpendicular to a side surface of motor gear 6 and rotating by motor gear 6, and an operation gear 8 rotating on a side surface of transmission gear 7 by transmission gear 7.

Motor gear 6 is formed in a rod type in which a worm gear is formed in an outer circumferential surface.

Transmission gear 7 includes a worm wheel 7a rotating through the worm gear, and a worm shaft 7b configured as a worm gear fixed to the axis center of worm wheel 7a and perpendicular to worm wheel 7a.

Worm wheel 7a has a circular shape in which a worm wheel gear is formed in the edge, and worm shaft 7b is formed in the rod type in which a worm gear is formed in an outer circumferential surface.

In various embodiments, worm shaft 7b has an end surface with a tool groove 7c formed therein. Since tool groove 7c is formed, it is possible to manually lock or release the parking release actuator by using a tool.

Tool groove 7c is formed in a straight shape or a cross shape so as to form the manual operation unit, and a hole is formed in housing 1 to allow a tool to be inserted to tool groove 7c.

Operation gear 8 is formed in a circular shape in which a worm wheel gear is formed in the edge, and a pin shaft 9 is connected to housing 1 and functions as the shaft center for rotating operation gear 8 by worm shaft 7b of transmission gear 7.

Cable guide 10 is fixed to the rear side of operation gear 8 together with pin shaft 9 and rotates similar to operation gear 8.

Cable guide 10 includes an extension end 10a extending in a fan shape from a shaft center portion fixed by pin shaft 9, and a fixing hole 10b is made in extension end 10a to fix cable 20, and a groove is formed in an edge surface thereof such that cable 20 wound when cable 20 is pulled can be contained inside extension end 10a.

In various embodiments, extension end 10a is formed to form 90 degrees from one side portion to fixing hole 10b and thus the entire angle is 90 degrees or more.

The sensor includes a magnet 11 having a north pole and a south pole, and a senor printed circuit board (PCB) 12 sensing a position change of magnet 11 and generating an electric signal to be transmitted to the controller.

That is, sensor PCB 12 is a type of detecting the north pole and the south pole of magnet 11 changed in position in an analog manner.

In various embodiments, the north pole and the south pole of magnet 11 are formed on both sides of left and right relative to the shaft center of operation gear 8 in an arc shape occupying an area smaller than 90 degrees, respectively.

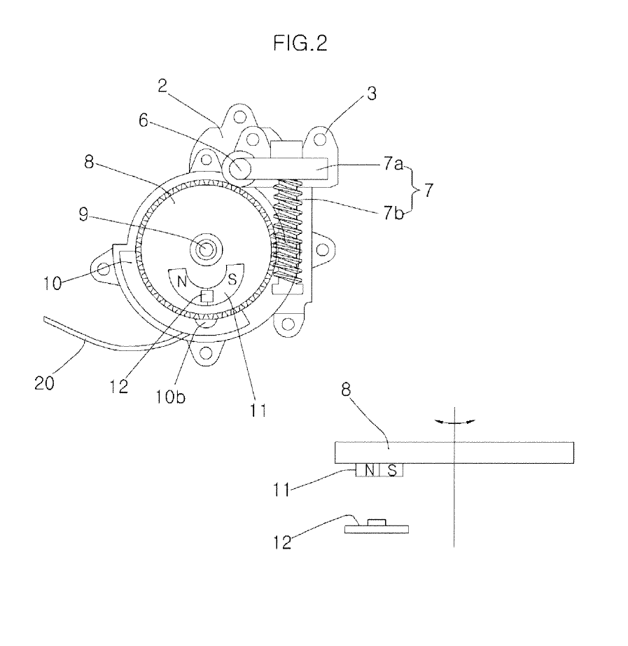

Referring to FIG. 2, worm wheel 7a is positioned on a side surface of motor gear 6 connected to motor 5 in the inner space of inner cover 2 and outer cover 3 constituting housing 1, and worm shaft 7b fixed to the shaft center of worm wheel 7a and perpendicular to worm wheel 7a is positioned on one side surface of the inner space.

In this case, both ends of worm shaft 7b are supported by a bearing to improve the rotation efficiency of worm shaft 7b.

Operation gear 8 rotating on the side surface of worm shaft 7b by worm shaft 7b is connected with pin shaft 9 and occupies the inner space of inner cover 2 and outer cover 3 constituting housing 1. Cable guide 10 is connected to the rear side of operation gear 8 together with pin shaft 9, and cable 20 is connected to cable guide 10.

Also, magnet 11 is positioned on one surface of operation gear 8, and sensor PCB 12 sensing magnet 11 is provided on outer cover 3 side.

As described above, the gear unit, cable guide 10, and the sensor are assembled together in the inner space of inner cover 2 and outer cover 3 constituting housing 1. The gear unit outputting a rotation torque by power of motor 5 makes cable guide 10 perform an angular motion so as to pull or release the cable 20.

That is, in various embodiments, the related motion between motor 5 and cable 20 uses rotation motions in different directions. Therefore, it is possible to make the gear unit and cable guide 10 compact and intensive so as to reduce the size of housing 1.

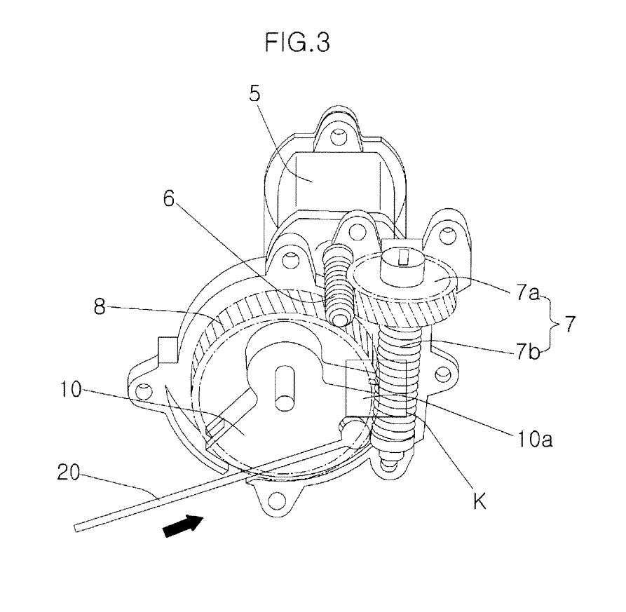

Referring to FIG. 3, if motor gear 6 rotates clockwise by a clockwise rotation of motor 5, worm wheel 7a and worm shaft 7b rotate clockwise by motor gear 6, and operation gear 8 fixed by pin shaft 9 rotates counterclockwise by worm shaft 7b.

The rotation of operation gear 8 counterclockwise rotates cable guide 10 connected to the rear side of operation gear 8 together with pin shaft 9, and the counterclockwise rotation of cable guide 10 pulls cable 20 so as to release parking.

In various embodiments, an angular motion range of cable guide 10 is implemented by sensing a position change of magnet 11 attached to operation gear 8 by sensor PCB 12 and controlling the driving of motor 5 by the controller receiving an electric signal of sensor PCB 12.

That is, if cable guide 10 counterclockwise rotates together with operation gear 8 to approach worm shaft 7b, at the same time of the approach, magnet 11 also rotates counterclockwise together with operation gear 8 such that the positions of the north pole and the south pole of magnet 11 are changed. If cable guide 10 further rotates, the positions of the north pole and the south pole of magnet 11 detected by sensor PCB 12 are also changed.

The position changes of the north pole and the south pole of magnet 11 is transmitted to the controller through sensor PCB 12 and thus the controller stops motor 5 to complete the parking release operation of the parking release actuator.

In this case, the end portion of extension end 10a of cable guide 10 is in close contact K with worm shaft 7b.

In various embodiments, even in a case where motor 5 stops, a force pulling cable 20 for parking release may be maintained, and this action results from a self locking structure which forms a friction by close contact K between cable guide 10 and worm shaft 7b and using the friction as a fixing force.

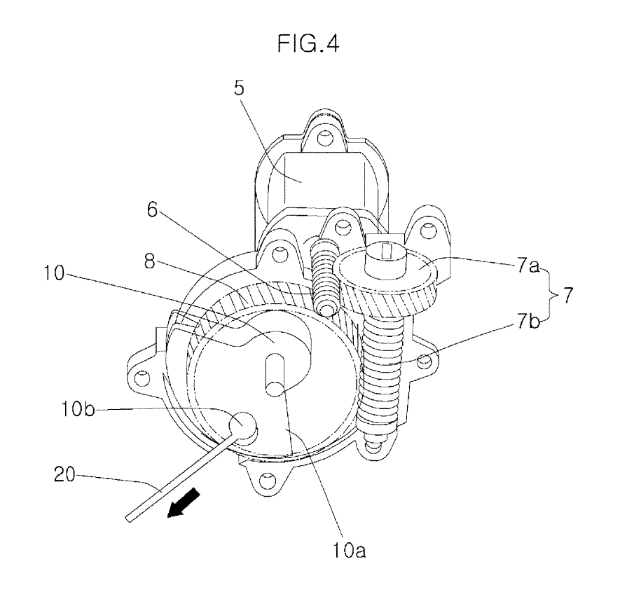

FIG. 4 is a view illustrating a parking release operation automatically implemented according to various embodiments of the present invention.

As shown in FIG. 4, if motor gear 6 rotates counterclockwise by the counterclockwise rotation (which is reverse to that for parking release) of motor 5, worm wheel 7a and worm shaft 7b rotate counterclockwise by motor gear 6, and operation gear 8 fixed by pin shaft 9 rotates clockwise by worm shaft 7b.

The rotation of operation gear 8 clockwise rotates cable guide 10 fixed to the rear side of operation gear 8 together with pin shaft 9 such that cable guide 10 moves away from worm shaft 7b by the clockwise rotation. As a result, the pulling of cable 20 is released such that the parking release actuator is switched to a parking state.

When cable guide 10 rotates clockwise as described above, the positions of the north pole and the south pole of magnet 11 rotating together with operation gear 8 are changed. If cable guide 10 further rotates, the positions of the north pole and the south pole of magnet 11 detected by sensor PCB 12 are also changed again.

The position changes of the north pole and the south pole of magnet 11 are opposite to those when parking is released. Therefore, the controller distinguishes parking release and parking locking from each other by an electric signal transmitted from sensor PCB 12.

The controller perceiving the position changes of the north pole and the south pole of magnet 11 through sensor PCB 12 stops motor 5 so as to complete a parking locking operation of the parking release actuator.

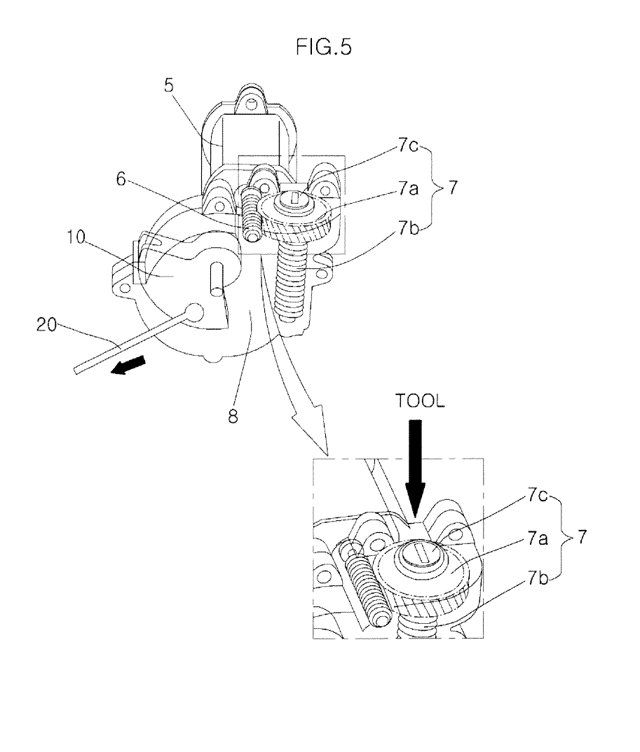

FIG. 5 shows a parking locking operation release manually implemented according to various embodiments of the present invention.

As shown in FIG. 5, if parking is manually locked due to a failure of motor 5, a tool such as a driver is inserted from the external of housing 1 into tool groove 7c formed in the end surface of worm shaft 7b.

If the tool is counterclockwise rotated in the state in which the tool is inserted into tool groove 7c, worm shaft 7b rotates counterclockwise through the tool.

The counterclockwise rotate of worm shaft 7b clockwise rotates operation gear 8 fixed by pin shaft 9 and thus cable guide 10 also rotates clockwise together with operation gear 8.

Since cable guide 10 moves away from worm shaft 7b by the clockwise rotation, the pulling of cable 20 is released so as to switch the parking release actuator to the parking state.

When the manual operation is performed, the detection of the positions of the north pole and the south pole of magnet 11 by sensor PCB 12 does not influence the manual operation.

In various embodiments, in order to switch the parking release actuator to the parking state, the tool directly rotates worm shaft 7b, and worm shaft 7b directly rotates operation gear 8 rotating together with cable guide 10 to which cable 20 is fixed. Therefore, the number of times of tool operation is greatly reduced to about 6.5.

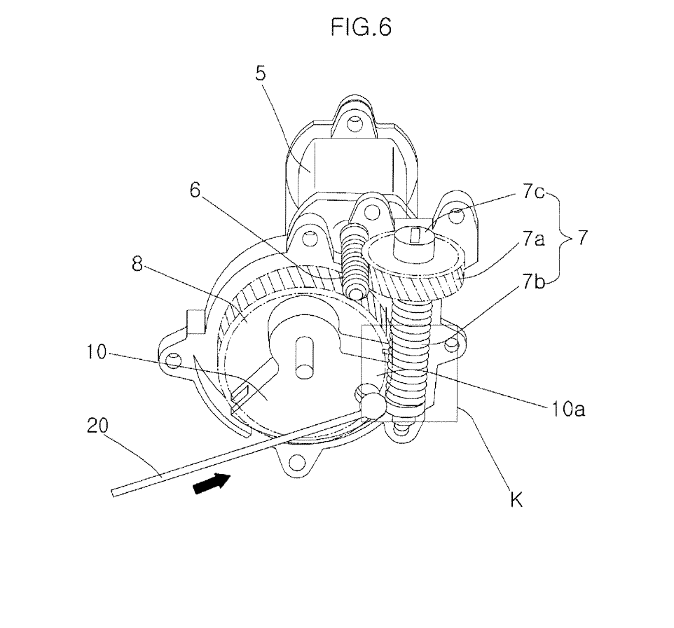

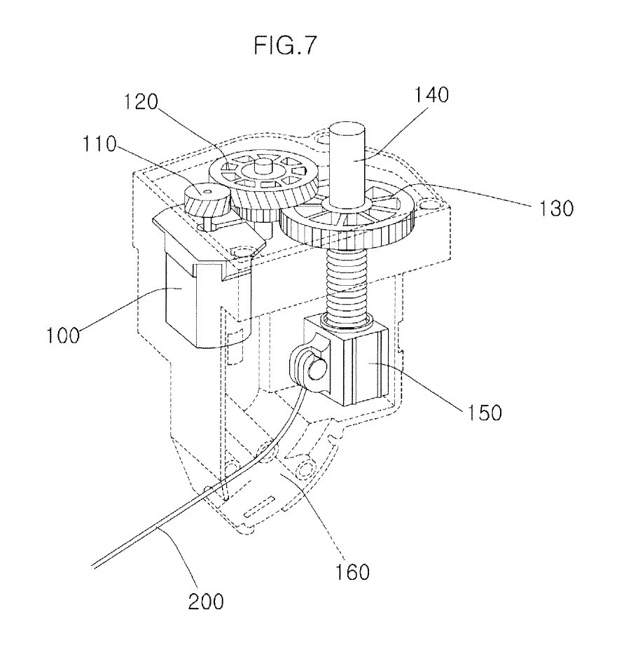

FIG. 6 shows a parking release operation manually implemented according to various embodiments of the present invention.

As shown in FIG. 6, if parking is manually released due to a failure of motor 5, a tool such as a driver is inserted from the external of housing 1 into tool groove 7c formed in the end surface of worm shaft 7b.

If the tool is clockwise rotated in the state in which the tool is inserted into tool groove 7c, worm shaft 7b rotates clockwise through the tool.

The clockwise rotate of worm shaft 7b counterclockwise rotates operation gear 8 fixed by pin shaft 9 and thus cable guide 10 also rotates counterclockwise together with operation gear 8.

Since cable guide 10 approaches worm shaft 7b by the counterclockwise rotation, cable 20 is pulled so as to switch the parking release actuator to a parking release state.

In this case, the edge portion of extension end 10a of cable 20 is in close contact K with worm shaft 7b and thus self locking fixed by the friction formed between cable guide 10 and worm shaft 7b is implemented.

When the manual operation is performed, the detection of the positions of the north pole and the south pole of magnet 11 by sensor PCB 12 does not influence the manual operation.

Also, when the manual operation is performed, the number of times of tool operation is greatly reduced to about 6.5, similar to when the parking is locked.

As described, in the parking release actuator according to various embodiments, the related motion between motor 5 and cable 20 uses a number of worm gears and worm wheel gears using rotation motions in different directions, and cable 20 is pulled or released by cable guide 10 converting a rotation motion into an angular motion. Therefore, a number of worm gears and worm wheel gears and cable guide 10 are made compact and intensive. As a result, it is possible to reduce the entire size of housing 1 and significantly reduce the operation of the operator required for manual locking or manual release, thereby further improving the convenience.

For convenience in explanation and accurate definition in the appended claims, the terms rear and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A parking release actuator, comprising:
a motor providing a power source;
a gear unit aligned perpendicular to the motor, and outputting power of the motor as a final torque in an opposite direction to a rotation direction of the motor;
a cable guide performing an angular motion according to the output of the gear unit to pull or release a cable according to a rotation direction of the angular motion;
a sensor generating a detection signal for stopping the motor such that the cable guide is positioned in a predetermined angular motion range;
a manual operation unit formed in the gear unit to rotate the gear unit by using a tool; and
a housing containing the gear unit, the cable guide, and the sensor perpendicular to a containing portion of the motor, and having a hole through which the tool is inserted.

2. The parking release actuator as defined in claim 1, wherein the housing includes an inner cover and an outer cover having respective shapes corresponding to each other and joined with each other, and the inner cover has a motor containing unit housing the motor.

3. The parking release actuator as defined in claim 1, wherein the gear unit includes a motor gear joined with the motor in a shaft direction of the motor to rotate, a transmission gear perpendicular to a side surface of the motor gear and rotating by the motor gear, and an operation gear fixed to the housing by a pin shaft to rotate on a side surface of the transmission gear by the transmission gear.

4. The parking release actuator as defined in claim 3, wherein the transmission gear includes a worm wheel engaged with a worm gear formed in an outer circumferential surface of the motor gear, and a worm shaft fixed to a shaft center of the worm wheel, perpendicular to the worm wheel, and provided with a worm gear formed in an outer circumferential surface engaged with a worm wheel gear formed in the edge of the worm wheel.

5. The parking release actuator as defined in claim 4, wherein a tool groove is formed in an end surface of the worm shaft to join with the tool as the manual operation unit.

6. The parking release actuator as defined in claim 1, wherein the cable guide includes an extension end extending in a fan shape from a shaft center portion fixed to the rear of the operation gear by the pin shaft, and a fixing hole is made in the extension end to fix the cable.

7. The parking release actuator as defined in claim 6, wherein a groove is formed in an edge surface of the extension end to wind the cable.

8. The parking release actuator as defined in claim 6, wherein the fixing hole is formed at a position forming 90 degrees with one side portion of the extension end.

9. The parking release actuator as defined in claim 1, wherein the sensor includes a magnet having a north pole and a south pole, and a sensor printed circuit board (PCB) sensing a position change of the magnet and generating an electric signal to be transmitted to a controller.

10. The parking release actuator as defined in claim 9, wherein the north pole and the south pole of the magnet are formed on both sides of left and right relative to a shaft center of the operation gear in an arc shape occupying an area smaller than 90 degrees, respectively.
